(19) United States
(12) Patent Application Publication
(10) Pub. No.: US 2008/0098017 A1
(43) Pub. Date: Apr. 24, 2008

(54) Method and Device for Executing a Watermark-Embedded Content

(76) Inventors: Sang Hyun Joo, Daejeon (KR); Bum Suk Choi, Daejeon (KR); Hye Joo Lee, Daejeon (KR); Jin Soo Choi, Daejeon (KR); Jin Woo Hong, Daejeon (KR); Jong Won Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/575,987

(22) PCT Filed: Oct. 20, 2005
(86) PCT No.: PCT/KR05/03497

§ 371 Date: Mar. 26, 2007

(30) Foreign Application Priority Data
Oct. 20, 2004 (KR) 10-2004-0084169

(51) Int. Cl. G06F 17/30

(52) U.S. Cl. 707/101; 707/E17.009

(57) ABSTRACT

Provided are an extended multimedia file structure, a multimedia file producing method, and a multimedia file executing method. The extended multimedia file structure includes: a metadata section including a media initial object descriptor (IOD) field and at least one track pointer; and a media data section including at least one media block indicated by the track pointer, wherein the at least one track pointer indicates a detail media resource contained in an embedded multimedia file or an external multimedia file.

### TECHNICAL FIELD

The present invention relates to a method and device for executing contents including data in which unalterable information is recorded using watermark technology.

### BACKGROUND ART

Thus far, attempts by the secure digital music initiative (SDMI) and the copy protection technical working group (CptWG) affiliated with the digital versatile disc (DVD) forum to apply a conventional digital watermark system to portable devices have failed due to the tenacity (i.e. incompatibility) of a watermark algorithm.

Meanwhile, a portable audio and video (PAV) system includes a device for protecting contents with a digital rights management (DRM) system first. Specifically, since the contents is protected by encryption technology and thus can be accessed by only a legal user, the PAV system has an advantage in that the DRM encryption technology must be attacked first in order to remove or forge a watermark hidden in the content.

The encryption technology is widely known for its safety, which has intensified in the twenty-first century because the American national institute of standards and technology (NIST) selected an advanced encryption standard (AES) algorithm.

Therefore, the safety of the encryption technology against malicious attacks on a watermark algorithm can be guaranteed.

While conventional watermark technology guarantees safety, due to essential rigidity of the encryption technology, it is difficult to apply the watermark technology to recording a variety of information or to make different conventional watermark technologies compatible with one another.

### DISCLOSURE OF INVENTION

### Technical Problem

It is an object of the present invention to provide a method and device for executing contents employing watermark technology that can facilitate recording of a variety of information including stateless rights information in the content.

It is another object of the present invention to provide a method and device for executing contents employing watermark technology that can prevent a variety of information from being lost, forged, or altered during a contents data transmission process.

It is yet another object of the present invention to provide a method and device for executing contents having a watermark structure that can accept various watermark technologies.

### Technical Solution

One aspect of the present invention provides a contents execution device comprising: a decryptor for decrypting a contents packet with a predetermined algorithm and dividing the contents packet into a contents portion that include contents to be executed and a non-contents portion that include metadata and/or license related information; a non-contents portion reader for reading the non-contents portion and examining state rights information; a watermark extractor for extracting watermarked stateless rights information from the contents portion; and a rights manager for receiving the state rights information and the stateless rights information and determining whether execution rights for the contents are present.

Another aspect of the present invention provides a contents packet structure comprising: a contents portion including a contents stream of continuous units of contents data; and a non-contents portion including bibliographic information, wherein the each unit contents data includes rights information about itself in watermark form.

Yet another aspect of the present invention provides a contents execution method comprising the steps of: extracting a watermark from each unit of contents data; and confirming execution rights for the corresponding unit of contents data from the watermark, and when the rights are confirmed, executing the corresponding unit of contents data.

### ADVANTAGEOUS EFFECTS

With the method and/or device for executing contents according to the present invention, it is possible to prevent loss, forgery, or alteration of stateless rights information.

Also, with the method and/or device for executing contents according to the present invention, it is possible to easily record a variety of information including stateless rights information in contents data.

Also, with the method and/or device for executing contents according to the present invention, it is possible to implement a variety of watermark technologies.

Also, with the method and/or device for executing contents according to the present invention, it is possible to grant different execution rights to each unit of contents data such as a frame or scene.

### BRIEF DESCRIPTION OF THE DRAWINGS

FIG. 1 is a block diagram of a contents execution device according to an exemplary embodiment of the present invention;

FIG. 2 illustrates the structure of watermark information according to an exemplary embodiment of the present invention;

FIG. 3 illustrates the structure of watermark information for restricting viewing of a portion of contents in which it is embedded according to an exemplary embodiment of the present invention; and

FIG. 4 is a flowchart illustrating a contents execution method according to an exemplary embodiment of the present invention.

### MODE FOR THE INVENTION

Information hiding or digital watermark technology performs hiding predetermined information in contents without perceptibility injury of contents data. Though, the original purpose of digital watermark technology is copyright marking to protect copyright of multimedia contents by hiding copyright information, the digital watermark technology can be used of metadata tagging or integrity verification of contents as application area expanded.

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those of ordinary skill in the art.

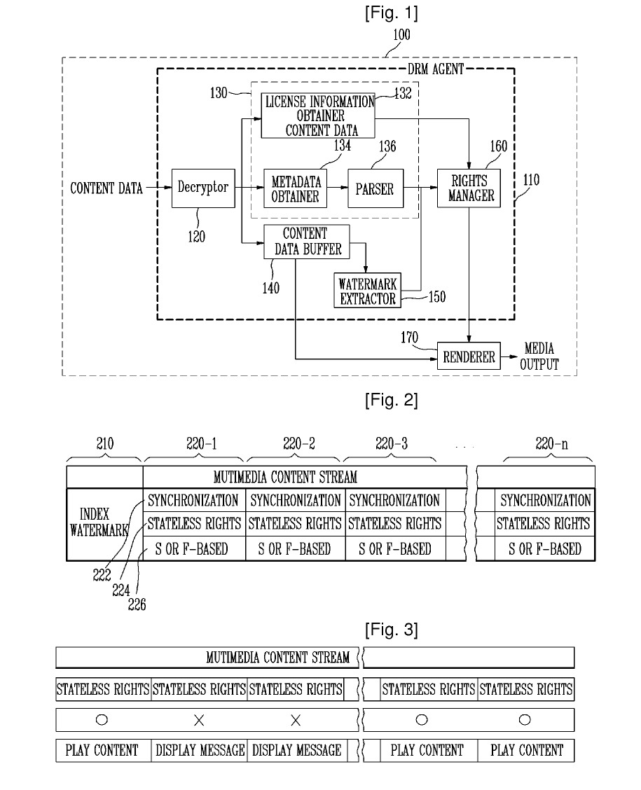

FIG. 1 illustrates an exemplary embodiment of a device for executing contents according to the present invention.

A decryptor 120 separates a contents portion including a contents stream and a non-contents stream not including a contents stream. The contents portion and the non-contents portion are separated in order to divide data that should be separately processed by different methods. The portions can be separated simply by giving them separate physical locations such as a header and a tailer. When additional information, that is included not in contents data but in metadata and so forth, is not separated by physical location but hidden in the contents data by a watermark or the like, even the additional information is disposed in the contents portion.

A non-contents portion reader 130 reads information included in the non-contents portion. According to the spirit of the present invention, it is particularly important to examine state rights information in a license.

In the structure shown in FIG. 1, the non-contents portion reader 130 may include a license information obtainer 132 for obtaining license-related information from the non-contents data; and a metadata obtainer 134 for obtaining metadata required for executing contents from the non-contents data. The license information obtainer 132 and the metadata obtainer 134 may include buffer memories for temporarily storing corresponding data.

In addition, the non-contents portion reader 130 may further include a parser (not shown in drawings) for parsing the information obtained from the license information obtainer 132 and/or a parser 136 for parsing the information obtained from the metadata obtainer 134.

A watermark extractor 150 extracts additional data hidden (watermarked) in the contents data. The additional data recorded in the watermark may be general metadata that can be recorded in the non-contents portion. However, since watermarked data is hidden from the outside and resistant to forgery and alteration, the additional data recorded in the watermark is preferably stateless rights information of copyright information. Stateless rights information is a data value that is fixed at the point of time when rights (license) are granted and does not vary during the valid period of the rights, whereas state rights information is a data value that varies and is recorded during the valid period of the rights. The stateless rights information may be main license information such as a certificate that shows rights, and the state rights information may be rights limitation information including a number of plays, a number of recordings, and so forth that are changed and recorded.

A rights manager 160 confirms a license of the contents to be executed. The rights manager 160 is similar to a conventional rights manager of a multimedia player that performs rights confirmation, but classifies the state rights information and stateless rights information to perform license confirmation according to the present invention.

The stateless rights information received from the watermark extractor 150 may be confirmed every time each unit of contents data (image data can be a frame or a scene that is a collection of a predetermined number of frames) is played.

In some embodiments, the rights manager 160 may receive data (hereinafter called external license data) relative to the license of the corresponding contents from the outside through a network and so forth, put together the state rights information, stateless rights information, and external license data, and make a determination on execution rights for the corresponding content.

In addition, a contents execution device 100 of this embodiment may further include a renderer 170 for outputting contents data into a multimedia stream made up of sound and/or image information. The renderer 170 is required for the contents execution device 100 to operate as a multimedia terminal. However, the renderer 170 is not central to the present invention so a detailed description thereof will be omitted.

Referring to FIG. 1, the contents execution device 100 can be divided into a part that processes contents data, a part that confirms and enforces execution rights, and a part that decrypts contents encrypted into a predetermined format and sends the decrypted contents to the renderer 170. Among the parts, the contents data processing part, the execution-rights managing part, and the contents data decrypting part can be united by operations of a digital rights management (DRM) agent.

In the description of the decryptor 120 both above and below, terms such as “encrypt” and “decrypt” are used. However, the present invention is not limited to the case where the contents data is encrypted, but rather the terms mean that the contents data is converted, i.e., encoded/decoded, into a predetermined format. The term “encrypt” is used because the contents data is preferably encrypted, and the term “decrypt” is used to distinguish the operation from decoding performed by the renderer 170.

Since watermark information is hidden in the contents portion, the watermark extractor 150 extracts the watermark information from the contents portion and communicates to the rights manager 160 in the contents execution device 100 that includes the watermark extractor 150 and is shown in FIG. 1, while the renderer 170 decodes the decrypted contents.

The decryptor 120 decrypts contents that is compression-encrypted by a compression technique into the playable data format and sends the decrypted contents to the renderer 170 and the watermark extractor 150. According to embodiments, the contents execution device 100 may further include a buffer 140 for temporarily storing the contents portion sent to the renderer 170 and the watermark extractor 150. The watermark extractor 150 sends the stateless rights information to the rights manager 160 which controls whether the contents can be played or not by performing a rights confirmation.

FIG. 2 illustrates an exemplary embodiment of a contents packet having watermark information according to the present invention. The illustrated packet structure comprises a contents portion 220 including a contents stream of continuous unit of contents data, and a non-contents portion 210 including bibliographic information.

Each of the unit of contents data 220-1 to 220-n has rights information 224 and 226 about corresponding unit contents hidden and stored therein in watermark form.

In addition, the non-contents portion 210 may include an index watermark required for extracting the watermark. The index watermark may include a mark indicating that watermarks are applied to the contents portion, and bibliographic information of the applied watermarks.

In addition, information hidden in the unit contents 220-1 to 220-n may include not only the stateless rights information but also scene-based rights information or frame-based rights information as illustrated in FIG. 2. An example of the scene-based rights information or frame-based rights information is playing rights information, shown in FIG. 3, based on film rating.

The information structure of FIG. 2 will be described in detail for the case of an image data stream. In a header of the data stream, there is an index watermark 210 in which watermark bibliographic information is recorded. And, a main body of the data stream includes the continuous frames 220-1 to 220-n. Specifically, in the illustrated embodiment, the respective watermarks are applied to a data unit of one frame (image data of one image). According to other embodiments, a scene which is a collection of several frames during a predetermined time or a frame can be the basic unit of the watermark data. As the information watermarked in each frame, it is preferable to record not only the stateless rights information but also a value, e.g., a film rating and an additional cost, which should differ from frame to frame.

Referring to FIG. 2, it can be seen that the watermark data structure for hiding the stateless rights information may vary according to type and expression method of the stateless rights information. Therefore, in the present invention, it is preferable to ensure a sufficient payload to support an expression method of the stateless rights information. Particularly, interoperability is preferably improved so that a portable audio and video (PAV) system is not restricted to a specific watermark technology. In order to achieve interoperability, the watermark data structure must be properly designed.

The stateless rights information is repeatedly inserted into each unit of data, so that security (integrity/authenticity) of the rights information can be fortified for contents in stream form also.

The embodiment of the watermark structure shown in FIG. 2 will be described in detail according to configuration fields. Information of the watermarks inserted into each frame and a required number of bits are defined as follows:
index watermark 210: When more than one watermark technologies are used, the registered watermark extractor should know what watermark technology is used in order to extract the stateless rights information from the contents data. The index watermark is for identifying the technology used. The index need not be a watermark and may be shown in the form of a header or execution data. When the index needs to be shown using watermark technology, one standardized open watermark technology is used, and the index watermark technology is selected by the principle of free license.
stateless rights information watermark 224: This is a portion in which information indicating rights that are fixed and do not vary is watermarked. Three bits can be allocated for rights information of one frame.
frame (or scene)-based rights 226: This is a portion for indicating rights separately allocated for each frame (or scene). Four bits can be allocated for each frame.

FIG. 3 illustrates a watermark data structure used in an exemplary embodiment of the present invention that watermarks contents whose viewing is restricted in accordance with a film rating.

Film rating rights can be shown through a PAV terminal using a variety of multimedia content, which can be classified as viewable contents or viewer-restricted contents based on age of the viewer. In general, television (TV) broadcasting displays a film rating in the form of an appropriate viewer age on a screen with a caption. However, a PAV terminal can represent and control a film rating by a more effective method. Conventional methods for applying film ratings simply display a film rating in characters on a screen or deny permission to download contents that is viewer-restricted by the film rating to underage users. Therefore, even when only a small section of contents is viewer-restricted by the film rating, the contents is restricted in its entirety from viewing by underage users. On the other hand, the present embodiment of the present invention can display film ratings for each frame or scene, and a multimedia player of this embodiment can control playing of contents in units of frames or scenes according to film ratings indicated in a contents stream. In other words, according to this embodiment, it is possible to provide moving picture contents excluding only those frames that are viewer-restricted by a film rating. Specifically, when a minor plays the frames viewer-restricted by the film rating with his/her terminal, the terminal recognizes a mark of a frame viewer-restricted by the film rating, stops playing the contents and instead displays a viewer-restriction mark of the film rating. A mark of each frame (or scene) that is viewer-restricted by the film rating is watermarked and thus hard to damage or alter.

Referring to FIG. 3, when the stateless rights information hidden in the multimedia contents is obtained per frame, it is determined whether or not each frame of the contents can be viewed with the stateless rights information. When the film rating allows, the contents is played. And when the film rating does not allow, the mark of the film rating and a message informing that viewing of the contents is restricted can be displayed instead of playing the content.

Meanwhile, another information value that can be watermarked is a playing termination period. Since rights for showing the playing termination period do not vary, the rights can be expressed as the stateless rights information. Therefore, the rights are hidden in and always together with the content, and its persistency be guaranteed to abrogation time of the contents. Referring to FIG. 3, in the same manner as an operation of the stateless rights information, the contents is played when the playing termination period has not yet lapsed. And, when the playing termination period lapses, the contents ceases to be played and a message is displayed to induce the user to buy an additional license or renew a license. Even in this case, the contents can be restricted frame by frame (or scene by scene). For example, when the contents includes information that should be open to the public or is offered for free in order to induce purchase of related contents (e.g. a trailer of a movie), a mark of an unlimited playing period (e.g. 0xffff), can be recorded as a watermark in each frame (or scene) to be made available for viewing, and a value of a playing termination period can be recorded as a watermark in each frame (scene) to be restricted. After the playing termination period has lapsed, only the frames (or scenes) including the mark of the unlimited playing period can be played.

As described above, the following items can be watermarked and recorded in each frame. Detailed descriptions thereof can be derived from the above description and thus will be omitted.
stateless rights information
frame- or scene-based rights
multilingual captions
captioning
teletext, etc.

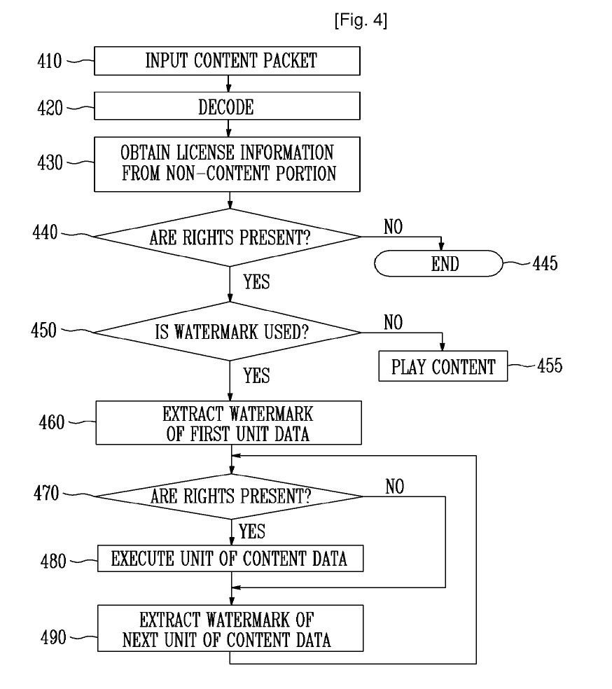

FIG. 4 illustrates an exemplary embodiment of a license confirmation method that is performed by a contents execution device according to the present invention.

As illustrated in FIG. 4, the method for executing contents that has a license structure according to the present invention comprises the steps of inputting a contents packet (410); decrypting the contents packet and classifying the contents packet into a contents portion and a non-contents portion (420); obtaining license-related information from the non-contents portion (430); confirming execution rights for corresponding contents from the obtained license-related information (440); when the rights cannot be confirmed, terminating execution of the contents; examining if the contents packet uses watermarks (450); when watermarks are not used, executing the entire contents according to a conventional method; extracting a watermark from each unit of contents data (460 and 490); confirming execution rights for corresponding unit of contents data from the watermark (470); and when the rights are confirmed, executing the corresponding contents data (480).

Since general contents data is formed into a stream and a moving picture has a considerable capacity, the contents packet input in step 410 may include only a part of a continuous stream rather than the entire content. Step 410 can be performed by storing the received contents packet in an input data buffer 110 in the contents playing terminal shown in FIG. 1.

In step 420, the contents packet that is encoded into a predetermined format is decoded and divided into the non-contents portion including bibliographic information about the contents and the contents portion including the contents data. In the structure shown in FIG. 2, the non-contents portion is made up of a license-related information part and a metadata part. The contents portion is stored in the contents data buffer 140. After step 430, the metadata is stored in the metadata buffer 134, and the license-related information is stored in the license information buffer 132.

For a contents packet having a conventional DRM structure, all license rights for the corresponding contents are confirmed in step 440, and thus the contents is allowed to be played or not according to the confirmation. In contrast, for a contents packet according to the present invention, only state rights information is confirmed in step 440. Alternatively, in step 440, the license rights may not be confirmed and it may only be confirmed whether or not the contents packet has the conventional DRM structure.

When the license-related information is examined and it is determined that the contents packet uses watermarks according to the present invention, a watermark is extracted from a first unit of contents data (460). Here, the unit of contents data may be a frame or scene as described above.

In step 470, the extracted watermark is examined and it is determined whether or not execution rights for the corresponding unit of contents data are present. For example, the execution rights may be determined by a film rating. When the execution rights are determined to be present, only the corresponding unit of contents data is played. Then, a watermark is extracted from the next unit of contents data (490), and steps 470 and 480 are repeated in order. Meanwhile, when the execution rights for the corresponding unit of contents data are determined to be missing, the corresponding unit of contents data is not played and an operation recorded in the watermark may be performed. When a film rating is determined as the execution rights for the corresponding unit of contents data, words can be recorded as the watermark can be displayed instead of the unit of contents data.

While the invention has been shown and described with reference to certain exemplary embodiments thereof, it will be understood by those skilled in the art that various changes in form and details may be made therein without departing from the spirit and scope of the invention as defined by the appended claims.

1. A contents packet structure comprising:
a contents portion including a continuous stream of a plurality of units of contents data; and
a non-contents portion including bibliographic information,
wherein the each unit contents data includes rights information about itself in watermark form.

2. The contents packet structure according to claim 1, wherein the non-contents portion includes information required for extracting the watermark.

3. The contents packet structure according to claim 1, wherein the rights information about the unit of contents includes film rating information.

4. A computer-readable recording medium recorded a contents packet structure comprising:
a contents portion including a continuous stream of a plurality of units of contents data; and
a non-contents portion including bibliographic information,
wherein the each unit contents data includes rights information about itself in watermark form.

5. A contents execution device comprising:
a decryptor for decrypting a contents packet with a predetermined algorithm and dividing the contents packet into a contents portion including contents to be executed and a non-contents portion;
a non-contents portion reader for reading the non-contents portion and examining state rights information;
a watermark extractor for extracting watermarked stateless rights information from the contents portion; and
a rights manager for receiving the state rights information and the stateless rights information and determining whether execution rights for the contents are present.

6. The contents execution device according to claim 5, further comprising a renderer for outputting data of the contents portion into a multimedia stream made up of sound and/or image information.

7. The contents execution device according to claim 5, wherein the non-contents portion reader includes:
a license information obtainer for obtaining license-related information from the non-contents portion; and
a metadata obtainer for obtaining metadata required for executing the contents from the non-contents data.

8. The contents execution device according to any one of claims 5 to 7, wherein the contents packet includes a plurality of units of contents data block, the watermark extractor extracts stateless rights information from each of the units of contents data block, and the rights manager determines whether execution rights for each of the units of contents data block are present.

9. The contents execution device according to claim 8, wherein the unit of contents data is data frame or data scene.

10. A method for executing contents packet made up of a plurality of units of contents data, comprising the steps of:
(f) extracting a watermark from each of the units of contents data; and
(g) confirming execution rights for each unit of contents data from the watermark, and when the rights are confirmed, executing the corresponding unit of contents data.

11. The method for executing contents according to claim 10, before step (f), further comprising the step of:
(e) examining if the contents packet uses the watermark.

12. The method for executing contents according to claim 10, before step (f), further comprising the steps of:
(b) dividing the contents packet into a contents portion and a non-contents portion;
(c) obtaining license-related information from the non-contents portion; and
(d) confirming execution rights for corresponding contents from the obtained license-related information.

13. The method for executing contents according to claim 12, before step (b), further comprising the step of:
(a) receiving the contents packet.

14. The method for executing contents according to claim 12, wherein when the execution rights cannot be confirmed in the result of step (d), the execution of the corresponding contents is terminated.

15. The method for executing contents according to claim 11, wherein when the watermark does not use in the result of step (e), the corresponding contents in its entirety is executed according to a general method.

16. The method for executing contents according to claim 10, comprising the steps of: when the execution rights cannot be confirmed in the result of step (g), not executing the corresponding unit of contents data and performing an operation recorded in the watermark.

17. The method for executing contents according to any one of claims 10 to 16,
wherein steps (f) and (g) are repeatedly performed in order for a first unit of contents data of the contents packet formed into a stream made up of the plurality of units of contents data to a last unit of contents data of the contents packet.

18. The method for executing contents according to claim 10, wherein the contents packet has the contents packet structure according to any one of claims 1 to 3.
